(19) United States
(12) Patent Application Publication
(10) Pub. No.: US 2018/0076696 A1
(43) Pub. Date: Mar. 15, 2018

(54) MOTOR AND METHOD FOR MANUFACTURING THE SAME

(71) Applicant: Nidec Corporation, Kyoto (JP)

(72) Inventors: Kosuke MIZUIKE, Kyoto (JP); Tsuyoshi HIROKAWA, Kyoto (JP); Kenji FUKAMI, Kyoto (JP); Koji KADOWAKI, Kyoto (JP)

(21) Appl. No.: 15/692,287

(22) Filed: Aug. 31, 2017

(30) Foreign Application Priority Data
Sep. 14, 2016 (JP) 2016-179469

(51) Int. Cl. H02K 11/33; H02K 11/00; H02K 5/08; H02K 15/14; H02K 15/02; H02K 1/16

(52) U.S. Cl. CPC H02K 11/33; H02K 11/0094; H02K 5/08; H02K 2211/03; H02K 15/02; H02K 1/16; H02K 15/14

(57) ABSTRACT

A stationary portion of a motor includes a stator core including teeth, an insulator covering a surface of the stator core, a coil including a conductive wire, a housing, and a circuit board. The housing includes a cylindrical portion in which the stator core is fixed to the outer circumference thereof and a base portion extending from the cylindrical portion radially outward. The circuit board is disposed above the base portion and below the stator core, to which the conductive wire is electrically connected. The insulator includes a tubular portion covering the outer circumference of the cylindrical portion and a vertically deformable elastic portion protruding from the tubular portion radially outward. The circuit board is fixed to the upper surface of a seat portion of the base portion. The circuit board is in contact with the lower surface of the elastic portion radially inside the seat portion.

### CROSS REFERENCE TO RELATED APPLICATIONS

This application claims the benefit of priority to Japanese Patent Application No. 2016-179469 filed on Sep. 14, 2016. The entire contents of this application are hereby incorporated herein by reference.

### BACKGROUND OF THE INVENTION

### 1. Field of the Invention

The present disclosure relates to a motor and a method for manufacturing the motor.

### 2. Description of the Related Art

There is a known brushless motor including a circuit board on which electronic components and so on are mounted. In this type of brushless motor, a drive current is supplied to a coil via the circuit board. Japanese Laid-open Patent Application Publication No. 11-18385 discloses a structure in which a circuit board on which electronic components and so on are mounted is fixed to a housing.

In manufacturing the motor disclosed in Japanese Laid-open Patent Application Publication No. 11-18385, a unit including a stator and the circuit board is fixed to the housing. At that time, a load may be imposed on the circuit board to deform the circuit board. The deformation of the circuit board can damage a conductive wire connected to the circuit board.

### SUMMARY OF THE INVENTION

A motor according to an exemplary embodiment of the present disclosure includes a stationary portion including a stator and a rotor configured to rotate about a central axis extending in a vertical direction. The stationary portion includes a stator core, an insulator, a coil, a housing, and a circuit board. The stator core includes a plurality of teeth protruding outward in a radial direction. The insulator covers a surface of the stator core. The coil includes at least one conductive wire wound around the teeth via the insulator. The housing includes a cylindrical portion in which the stator core is fixed to an outer circumference thereof and a base portion extending from the cylindrical portion outward in the radial direction. The circuit board is disposed above the base portion and below the stator core. The conductive wire is electrically connected to the circuit board. The base portion includes a seat portion protruding upward. The insulator includes a tubular portion and at least one elastic portion. The tubular portion covers the outer circumference of the cylindrical portion. The elastic portion protrudes from the tubular portion outward in the radial direction. The elastic portion is elastically deformable in the vertical direction. The circuit board is fixed to an upper surface of the seat portion and in contact with a lower surface of the elastic portion radially inside the seat portion.

According to the exemplary embodiment of the present disclosure, the elastic portion is elastically deformed depending on the load from the circuit board. This reduces deformation of the circuit board. Therefore, damage to the conductive wire is reduced.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a longitudinal sectional view of a motor according to an embodiment of the present disclosure.

FIG. 2 is a fragmentary longitudinal sectional view of the motor according to the embodiment.

FIG. 3 is a bottom view of an insulator.

FIG. 4 is a flowchart illustrating a procedure of assembling a stator unit and a housing according to the embodiment.

FIG. 5 is a diagram illustrating how a motor is assembled (a comparative example).

FIG. 6 is a diagram illustrating how the motor is assembled (the comparative example).

FIG. 7 is a diagram illustrating how the motor according to the embodiment is assembled.

FIG. 8 is a diagram illustrating how the motor according to the embodiment is assembled.

FIG. 9 is a diagram illustrating how the motor according to the embodiment is assembled.

### DETAILED DESCRIPTION OF THE PREFERRED EMBODIMENTS

An exemplary embodiment of the present disclosure will be described hereinbelow with reference to the drawings. In the present disclosure, a direction parallel to the central axis of the motor is referred to as “axial direction”, a direction perpendicular to the central axis of the motor is referred to as “radial direction”, and a direction along an arc centered on the central axis of the motor is referred to as “circumferential direction”. In the present disclosure, the shapes of the components and the positional relationship among them will be described, with the axial direction as the vertical direction and the circuit board being lower than the stator. However, the definition on the vertical direction is not intended to limit the orientation of the motor according to an embodiments of the present disclosure at the time of manufacturing and in operation.

### 1. Structure of Motor

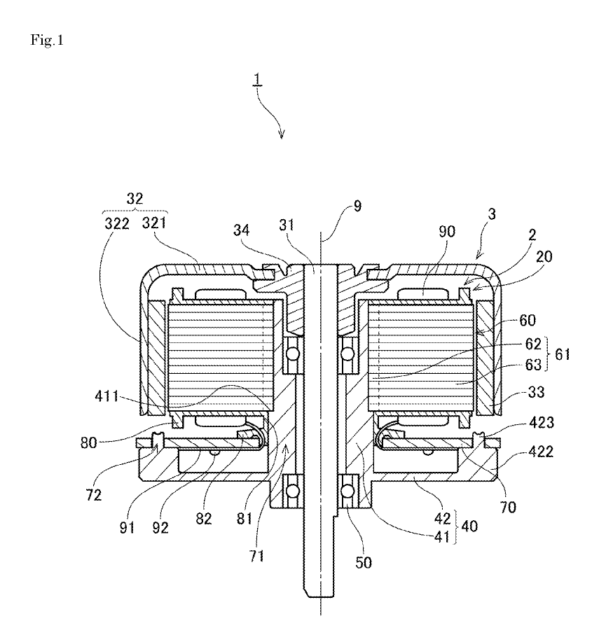

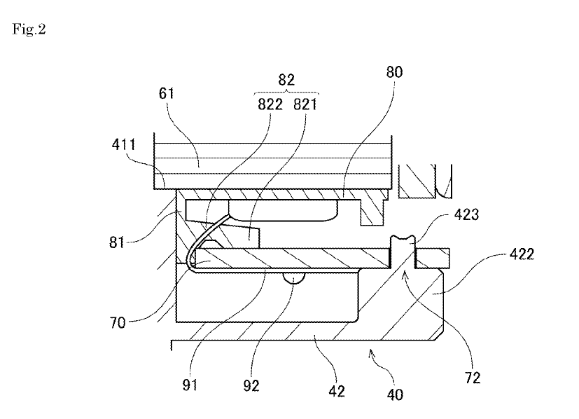

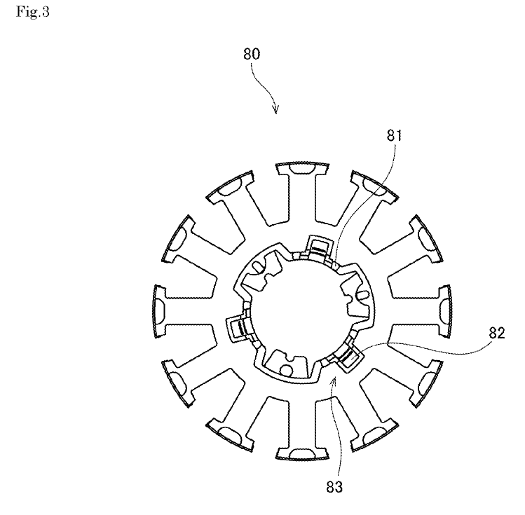

FIG. 1 is a longitudinal sectional view of a motor according to an embodiment. FIG. 2 is a fragmentary longitudinal sectional view of the motor 1 in the vicinity of a circuit board 70. FIG. 3 is a bottom view of an insulator 80. The motor 1 is for use in a small robot, such as a service robot. However, a motor with a similar structure may be used in household appliances, industrial machinery, and other applications.

As illustrated in FIG. 1, the motor 1 includes a stationary portion 2 and a rotor 3. The stationary portion 2 is fixed to the casing of a machine in which the motor 1 is mounted. The rotor 3 is rotatably supported with respect to the stationary portion 2.

As illustrated in FIG. 1, the rotor 3 includes a shaft 31, a rotor holder 32, and a plurality of magnets 33.

The shaft 31 is a columnar member extending in the axial direction. An example of the material of the shaft 31 is metal, such as stainless steel. At least part of the shaft 31 is positioned inside the housing 40 in the radial direction. The shaft 31 is rotatably supported by the housing 40 via a bearing portion 50.

The rotor holder 32 rotates together with the shaft 31 while holding the plurality of magnets 33. An example of the material of the rotor holder 32 is metal, such as iron which is a magnetic material. The rotor holder 32 includes a holder top plate 321 and a holder cylindrical portion 322. The holder top plate 321 expands substantially vertically with respect to the central axis 9. The inner circumferential portion of the holder top plate 321 is connected to the upper part of the shaft 31 via a connecting member 34. Thus, the rotor holder 32 and the shaft 31 are fixed to each other. The holder cylindrical portion 322 extends in a cylindrical shape from the outer circumferential portion of the holder top plate 321 downward in the axial direction.

The plurality of magnets 33 are fixed to the inner circumferential surface of the holder cylindrical portion 322. The plurality of magnets 33 are positioned outside a stator 60 in the radial direction. The inner surface of each magnet 33 in the radial direction is a magnetic pole face facing an end face of each of teeth 63, described later, in the radial direction. The plurality of magnets 33 are arranged at equal intervals in the circumferential direction such that an N-pole face and an S-pole face are alternately arranged. Instead of the plurality of magnets 33, one ring-shaped magnet in which N-pole and S-pole are alternately magnetized in the circumferential direction may be used.

The stationary portion 2 includes a stator unit 20, the housing 40, and the bearing portion 50.

The housing 40 is a member that supports the shaft 31 rotatably about the central axis 9. The housing 40 includes a cylindrical portion 41 and a base portion 42. The cylindrical portion 41 extends in a substantially cylindrical shape in the axial direction radially outside the shaft 31 and the bearing portion 50 and radially inside the stator 60 and the circuit board 70. A step-like first seat portion 411 is provided around the outer circumferential surface of the cylindrical portion 41. The outside diameter of the cylindrical portion 41 above the first seat portion 411 is smaller than the outside diameter of the cylindrical portion 41 below the first seat portion 411.

The base portion 42 is positioned below the circuit board 70 and expands radially outward in a substantially disc shape from the outer circumferential surface of the cylindrical portion 41. The base portion 42 includes a second seat portion 422 that protrudes upward at the radially outer end. The base portion 42 also includes a protrusion 423 that protrudes upward from the upper surface of the second seat portion 422.

The bearing portion 50 is a mechanism for rotatably supporting the shaft 31. The bearing portion 50 of the present embodiment employs a ball bearing that rotates an outer ring and an inner ring relative to each other via balls. The outer ring of the bearing portion 50 is fixed to the inner circumferential surface of the cylindrical portion 41. The inner ring of the bearing portion 50 is fixed to the outer circumferential surface of the shaft 31.

The stator unit 20 includes the stator 60 and the circuit board 70.

The stator 60 is an armature fixed to the outer circumferential surface of the cylindrical portion 41. The stator 60 includes a stator core 61, an insulator 80, and a coil 90. The stator core 61 is a laminated steel plate in which magnetic steel sheets, such as silicon steel sheets, are laminated in the axial direction.

The stator core 61 includes a ring-shaped core back 62 surrounding the central axis 9 and a plurality of teeth 63 protruding from the core back 62 outward in the radial direction. The plurality of teeth 63 are arranged at substantially regular intervals in the circumferential direction. Each tooth 63 extends radially with respect to the central axis 9. The lower surface of the core back 62 is in contact with the first seat portion 411 in the axial direction. Thus, the stator core 61 is fixed to the cylindrical portion 41 while being positioned in the axial direction.

The insulator 80 is attached to the core back 62 and the teeth 63. The insulator 80 is made of resin which is an insulating material. The upper surface and the lower surface of the teeth 63 are covered with the insulator 80. As illustrated in FIGS. 1 to 3, the insulator 80 includes a tubular portion 81 and elastic portions 82. The tubular portion 81 covers the outer circumferential surface of the cylindrical portion 41 of the housing 40. The elastic portions 82 protrude radially outward from the tubular portion 81. The elastic portions 82 can be elastically deformed in the vertical direction under a load in the axial direction.

The coil 90 is formed by winding conductive wires 91 around the teeth 63 via the insulator 80. The insulator 80 electrically insulates the teeth 63 and the conductive wires 91 from each other by intervening between the teeth 63 and the conductive wires 91.

The circuit board 70 is a substrate on which an electronic circuit for applying a drive current to the coil 90 is mounted. The circuit board 70 expands in a substantially disc shape in the radial direction and the circumferential direction below the stator core 61, above the base portion 42, and radially outside the shaft 31 and the cylindrical portion 41. A plurality of electronic components that constitute the electronic circuit are disposed on the upper surface and the lower surface of the circuit board 70. The plurality of electronic components include an electronic component that generates heat during driving, such as a field-effect transistor (FET).

In the motor 1, when a drive current is applied to the coil 90 via the circuit board 70, magnetic flux is generated in the plurality of teeth 63 of the stator core 61. By the action of the magnetic flux between the teeth 63 and the magnets 33, s circumferential torque is generated. This causes the rotor 3 to rotate about the central axis 9 with respect to the stationary portion 2.

### 2. Fixing Structure of Circuit Board

The circuit board 70 of the present embodiment includes a central hole 71 and a through-hole 72 radially outside the central hole 71. The cylindrical portion 41 of the housing 40 is inserted in the central hole 71. Thus, the circuit board 70 is disposed radially outside the cylindrical portion 41. The conductive wires 91 drawn from the coil 90 pass through the central hole 71 and are fixed to the lower surface of the circuit board 70 by soldering. Thus, the circuit board 70 and the conductive wires 91 are electrically connected to each other. By drawing out the conductive wires 91 from the central hole 71 described above, the need for providing a through-hole for drawing the conductive wires 91 in the circuit board 70 separately from the central hole 71 is eliminated. This reduces the number of man-hours involved in processing the circuit board 70.

The protrusion 423 of the second seat portion 422 is inserted in the through-hole 72 of the circuit board 70 radially outside the central hole 71. The upper surface of the circuit board 70 is in contact with the lower surface of the elastic portions 82 radially inside the second seat portion 422. A downward pressing force is applied to the protrusion 423 at the time of manufacturing the motor 1. This causes the protrusion 423 to be plastically deformed on the upper surface of the circuit board 70. In this way, the circuit board 70 is fixed to the upper surface of the second seat portion 422 by so-called caulking. Thus, the stator unit 20 is fixed to the housing 40.

The elastic portions 82 can be elastically deformed in the vertical direction according to the load from the circuit board 70. When a vertical load is applied to the circuit board 70 at the time of manufacturing or using the motor 1, the elastic portions 82 bend, so that the load on the circuit board 70 is dispersed. This reduces deformation of the circuit board 70. The reduction in the deformation of the circuit board 70 also reduces an excessive load on the conductive wires 91 fixed to the circuit board 70. This reduces damage to the conductive wires 91. In particular, the elastic portions 82 of the present embodiment extend from the tubular portion 81 outward in the radial direction. This provides a wide space radially inside the tubular portion 81. This increases flexibility in designing the portion radially inside the tubular portion 81.

As illustrated in FIG. 2, each elastic portion 82 of the present embodiment includes a thick-wall portion 821 and a thin-wall portion 822. The thin-wall portion 822 is positioned radially inside the thick-wall portions 821 and is thinner in the axial direction than the thick-wall portion 821. The circuit board 70 is in contact with only the thick-wall portion 821 out of the thick-wall portion 821 and the thin-wall portion 822. This causes the elastic portions 82 to tend to be elastically deformed. This further reduces damage to the conductive wires 91. The thin-wall portion 822 has a portion that decreases in thickness in the axial direction toward inside in the radial direction. This increases the tendency of the elastic portions 82 to be elastically deformed in the vertical direction. This further reduces damage to the conductive wires 91.

As illustrated in FIG. 3, the insulator 80 of the present embodiment includes the plurality of elastic portions 82 (three in the example of FIG. 3). The plurality of elastic portions 82 are disposed at regular intervals in the circumferential direction. This prevents the load applied to the circuit board 70 from the elastic portions 82 from being biased to a part in the circumferential direction. Accordingly, the load can be applied to the circuit board 70 equally in the circumferential direction when the stator core 61 is fixed to the housing 40.

The conductive wires 91 pass between the adjacent elastic portions 82 in circumferential direction and are drawn to the lower surface of the circuit board 70. At least one conductive wire 91 is disposed between the plurality of elastic portions 82 in the circumferential direction. This further reduces a bias in load applied to each conductive wire 91. This further reduces damage to the conductive wires 91.

As illustrated in FIG. 3, the insulator 80 of the present embodiment includes a wiring portion 83 radially outside the tubular portion 81, above the elastic portions 82, and radially inside the coil 90. The wiring portion 83 is a space for disposing the conductive wires 91 stretched across the coil 90 and expanding in the circumferential direction. Providing such a wiring portion 83 makes it easy to stretch the conductive wires 91.

### 3. Assembling Motor

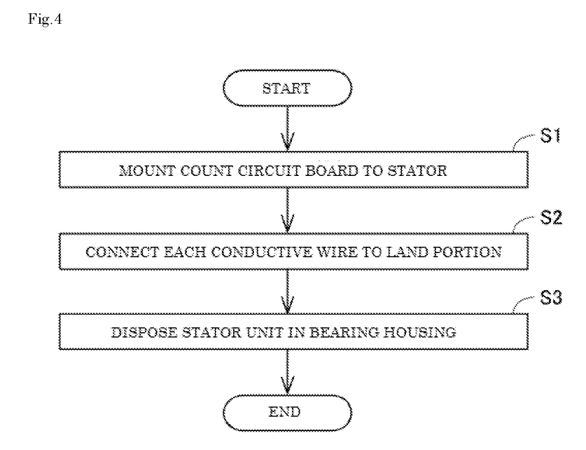

Next, part of a process of manufacturing the motor 1 according to the present embodiment will be described. FIG. 4 is a flowchart illustrating the procedure of assembling the stator unit 20 and the housing 40 out of the process of manufacturing the motor 1 described above.

In the example of FIG. 4, first, the circuit board 70 is mounted to the stator 60 (step S1). Here, the circuit board 70 is disposed below the insulator 80. Specifically, the circuit board 70 is brought close to the insulator 80 from below into contact with the elastic portions 82 of the insulator 80. In this way, the circuit board 70 is positioned in the axial direction with respect to the stator 60.

Next, the conductive wires 91 are drawn downward from the coil 90. The conductive wires 91 pass through the central hole 71 of the circuit board 70 and are drawn to the lower surface of the circuit board 70. The conductive wires 91 are individually connected to land portions 92 disposed on the lower surface of the circuit board 70 (step S2). In this way, the stator unit 20 including the stator 60 and the circuit board 70 is formed.

Thereafter, the stator unit 20 is disposed around the outer circumference of the cylindrical portion 41 of the housing 40 (step S3). In this case, the stator unit 20 is moved downward from above the cylindrical portion 41. The protrusion 423 of the second seat portion 422 is inserted into the through-hole 72 of the circuit board 70, and the circuit board 70 is brought into contact with the base portion 42. The lower surface of the stator core 61 is brought into contact with the first seat portion 411 of the housing 40.

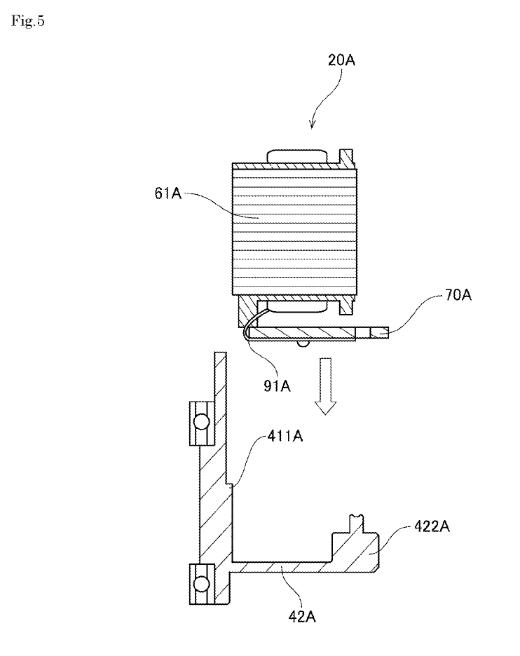

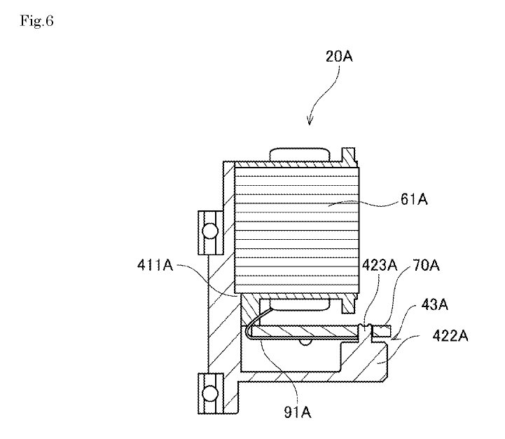

FIGS. 5 and 6 are diagrams illustrating how a motor according to a comparative example is assembled. In the example of FIGS. 5 and 6, a stator core 61A comes into contact with a first seat portion 411A before a circuit board 70A comes into contact with a second seat portion 422A. In this case, a gap 43A is produced between the upper surface of the second seat portion 422A and the circuit board 70A, as illustrated in FIG. 6. When a pressing force is applied from above the circuit board 70A toward a protrusion 423A of the second seat portion 422A, conductive wires 91A are pulled downward together with the circuit board 70A. This can damage the conductive wires 91A.

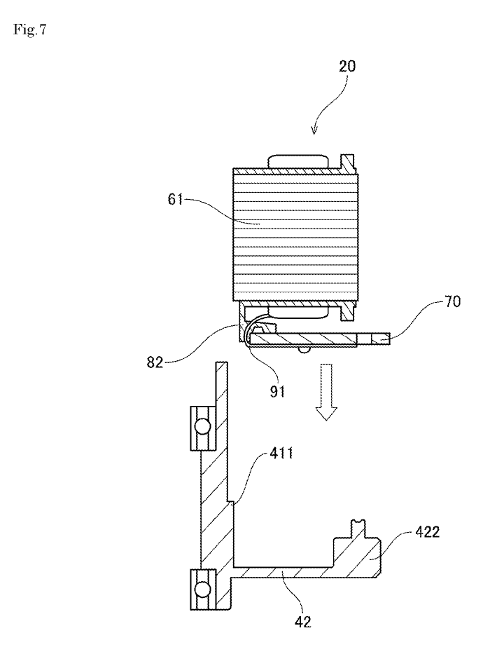

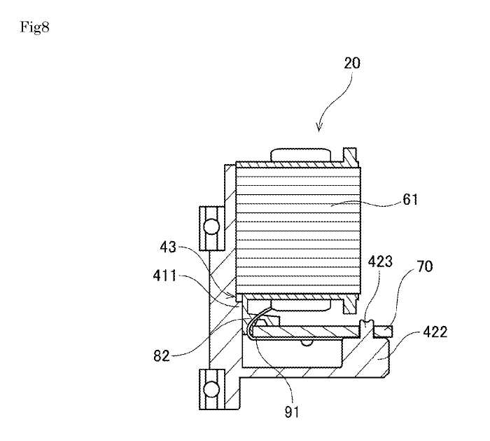

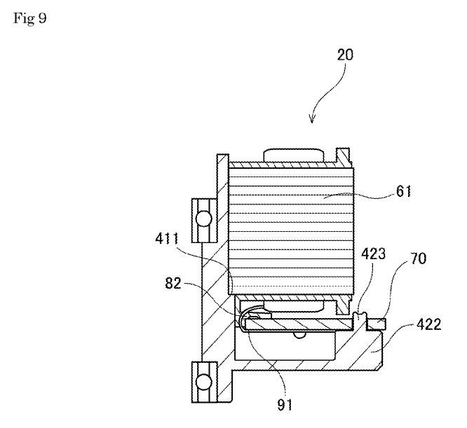

FIGS. 7 to 9 are diagrams illustrating how the motor 1 according to the present embodiment is assembled. In the present embodiment, the circuit board 70 is first brought into contact with the upper surface of the second seat portion 422. At that time, a gap 43 is produced between the first seat portion 411 and the lower surface of the stator core 61A, as illustrated in FIG. 8. Subsequently, the stator unit 20 is further moved downward to bring the stator core 61 into contact with the first seat portion 411. At that time, the circuit board 70 and the elastic portions 82 push each other in the axial direction. However, with the structure of the present embodiment, the elastic portions 82 are more easily elastically deformed in the axial direction than the circuit board 70. Therefore, mainly the elastic portions 82 are elastically deformed upward. This eliminates the gap 43 and reduces deformation of the circuit board 70. This deduces damage to the conductive wires 91 due to deformation of the circuit board 70.

Subsequently, a pressing force is applied to the protrusion 423 from above the circuit board 70. This causes plastic deformation of the protrusion 423, and the circuit board 70 is sandwiched between the second seat portion 422 and the plastically deformed portion of the protrusion 423. Thus, the circuit board 70 is fixed on the second seat portion 422. As a result, the stator unit 20 is fixed to the housing 40. In the case of the motor 1, the circuit board 70 is brought into contact with the housing 40 before the stator core 61 is. Therefore, the circuit board 70 is difficult to move downward when the protrusion 423 is plastically deformed. This also reduces damage to the conductive wires 91 due to the downward movement of the circuit board 70.

In particular, the motor 1 of the present embodiment is used to drive the joints of a small robot. In such application, vibrations due to an external force are likely to occur when the motor 1 is in use. However, with the structure of the present embodiment, the elastic portions 82 in contact with the circuit board 70 are deformed to absorb the vibrations. In other words, damage to the conductive wires 91 are reduced not only at the time of assembling but also in use.

### 4. Modification

Although an exemplary embodiment of the present disclosure has been described, the present disclosure is not limited to the embodiment.

In the above embodiment, a ball bearing is used as the bearing portion of the motor 1. However, instead of the ball bearing, a slide bearing, a fluid bearing, or another type of bearing may be used.

In the above embodiment, the second seat portion 422 and the circuit board 70 are fixed by caulking. However, the circuit board 70 may be fixed to the second seat portion 422 by another method, such as screwing.

In the above embodiment, the conductive wires 91 are fixed to the lower surface of the circuit board 70. Alternatively, the conductive wires 91 may be fixed to the upper surface of the circuit board 70. Also in the case where the conductive wires 91 are fixed to the upper surface of the circuit board 70, damage to the conductive wires 91 can be reduced by reducing deformation of the circuit board 70.

In the above embodiment, the tubular portion 81 and the elastic portions 82 of the insulator 80 form a single contiguous member. Alternatively, the tubular portion 81 and the elastic portions 82 may be separate members.

In the above embodiment, the number of elastic portions 82 is three. In some embodiments, the number of elastic portions 82 is either two or less or four or more.

The present disclosure may be used for, for example, a motor and a method for manufacturing the motor.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A motor comprising:
a stationary portion including a stator; and
a rotor configured to rotate about a central axis extending in a vertical direction;
wherein the stationary portion comprises:
a stator core including a plurality of teeth protruding outward in a radial direction;
an insulator covering a surface of the stator core;
a coil including at least one conductive wire wound around the teeth via the insulator;
a housing including a cylindrical portion in which the stator core is fixed to an outer circumference thereof and a base portion extending from the cylindrical portion outward in the radial direction; and
a circuit board disposed above the base portion and below the stator core, the conductive wire being electrically connected to the circuit board,
wherein the base portion includes a seat portion protruding upward,
wherein the insulator comprises:
a tubular portion covering the outer circumference of the cylindrical portion; and
at least one elastic portion protruding from the tubular portion outward in the radial direction, the elastic portion being elastically deformable in the vertical direction, and
wherein the circuit board is fixed to an upper surface of the seat portion and in contact with a lower surface of the elastic portion radially inside the seat portion.

2. The motor according to claim 1, wherein the circuit board is fixed to the seat portion due to plastic deformation due to a pressing force from above.

3. The motor according to claim 1,
wherein the circuit board has a through-hole,
wherein the seat portion has an upward protrusion,
wherein the protrusion is inserted in the through-hole, and
wherein the protrusion is plastically deformed.

4. The motor according to claim 1, wherein the circuit board is fixed to the seat portion with a screw.

5. The motor according to claim 1, wherein the conductive wire is connected to a lower surface of the circuit board.

6. The motor according to claim 5,
wherein the circuit board has a central hole radially inside the seat portion,
wherein the cylindrical portion is inserted in the central hole, and
wherein the conductive wire passes through the central hole and is drawn out to the lower surface of the circuit board.

7. The motor according to claim 1, wherein the conductive wire is fixed to the circuit board by soldering.

8. The motor according to claim 1,
wherein the elastic portion includes:
a thick-wall portion; and
a thin-wall portion positioned radially inside the thick-wall portion, the thin-wall portion being thinner in an axial direction than the thick-wall portion,
wherein, of the thick-wall portion and the thin-wall portion, only the thick-wall portion is in contact with the circuit board.

9. The motor according to claim 8, wherein the thin-wall portion includes a portion that decreases in thickness in the axial direction toward inside in the radial direction.

10. The motor according to claim 1,
wherein the at least one elastic portion comprises a plurality of elastic portions, and
wherein the at least one conductive wire is disposed between the plurality of elastic portions in a circumferential direction.

11. The motor according to claim 1, wherein the insulator further comprises a wiring portion expanding in the circumferential direction radially outside the tubular portion, above the elastic portion, and radially inside the coil.

12. The motor according to claim 1, wherein the tubular portion and the elastic portion are separate members.

13. A method for manufacturing the motor according to claim 1, the method comprising the steps of:
(a) disposing the circuit board below the stator;
(b) connecting the conductive wire drawn out of the coil to the circuit board to obtain a unit comprising the stator and the circuit board; and
(c) disposing the unit around the outer circumference of the cylindrical portion,
wherein, at step (c), the unit is moved downward from above the cylindrical portion to bring the base portion and the circuit board into contact with each other and thereafter bring the housing and the stator core into contact with each other.
